(19) United States
(12) Patent Application Publication
(10) Pub. No.: US 2014/0123600 A1
(43) Pub. Date: May 8, 2014

(54) MULTI-LAYER VALVE CONSTRUCTION HAVING FLUID SEALING LAYER

(71) Applicant: David Gardner, Strongsville, OH (US)

(72) Inventor: David Gardner, Strongsville, OH (US)

(21) Appl. No.: 14/153,391

(22) Filed: Jan. 13, 2014

Related U.S. Application Data
(63) Continuation of application No. PCT/US2012/046409, filed on Jul. 12, 2012.

(51) Int. Cl. B65D 77/22; F16K 15/14

(52) U.S. Cl. CPC B65D 77/225; F16K 15/14
USPC 53/410; 137/843; 220/62.13

(57) ABSTRACT

The present invention relates to a multi-layer control device and method of making that may be attached to a receptacle that provides a hermetic and/or water, fluid resistant seal but allows for the expulsion of air pressure from the interior of a receptacle. The multi-layer control device, more specifically a valve, has a fluid layer such as a low viscosity fluid that is applied during the manufacturing of the valve and incorporated into the layer of the valve. The valve includes a base layer that is provided over a first adhesive layer, a second adhesive layer is provided over the base layer, a fluid layer, a third adhesive layer and a cover layer. The second adhesive and fluid layers are discontinuous and are applied to the perimeter of the base layer, respectively. The base layer, first adhesive layer, and material layer have at least one aperture to facilitate the release of gas or fluid from the interior of a receptacle.

### CROSS-REFERENCE TO RELATED APPLICATION

The present application is a continuation application of PCT Application PCT/US2012/046409, filed Jul. 12, 2012, which claims the benefit of U.S. Provisional Patent Application No. 61/507,581 filed Jul. 13, 2011, each of which is incorporated herein by reference in its entirety.

### FIELD

The present invention relates to fluid control devices, such as valves. More specifically, the present invention relates to a one-way valve assembly that provides a hermetic and/or fluid resistant seal but which allows for the expulsion of gas and related pressure from the interior of a receptacle.

### BACKGROUND

Various types of packaging options are available today and are often used by consumers, industries, and numerous retailers to store food and other consumables for later use or consumption. It is also important for specific food retailers to present a product that appears attractive and desirable to consumers to increase product sales and promotion of the particular brand.

Coffee beans have a tendency to release a significant amount of gas after the roasting process when the coffee beans have already been placed in a sealed container. This presence of excessive gas within the sealed container may result in the container bulging and changing its shape or even bursting which makes the product unattractive to consumers and directly impacts the manufacturer by decreasing the amount of sales of those coffee beans. In addition retailers may also be impacted by having to clean store or warehouse shelves and remove contaminants from other packages and products that have burst due to excess gas within a container.

As a result of this tendency for roasted coffee beans to release gas, valves have heretofore been applied to packages containing roasted coffee beans in order to release this gas from the interior of the container to the external environment. In order to provide a seal, an oil layer is sometimes applied to coffee valves by the converter or roaster which adds additional protection to the container from the outside environment. The oil layer is disposed between the valve assembly and the package. Currently, the package converter applies the oil to the lower surface of the valve after manufacturing of the package but before application of the valve to the package containing the coffee beans. This is inefficient and can result in a large amount of waste and mess because the converter may not correctly add the oil to the valve, in that too much (or too little) oil may be applied. If the oil is not properly applied by the converter, the valve may not operate correctly destroying the integrity of the package and potentially limiting the freshness of product within the container.

A need exists in the marketplace for a valve assembly that has a controlled amount of oil built into the valve assembly before application of the valve assembly to a particular package containing product. Such a construction would help in reducing waste and mess and stream line the manufacturing process. What is needed therefore is a valve that has a pre-applied, predetermined amount of oil that would be applied without the possibility of converter error.

### BRIEF SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention provides a multi-layer fluid control device having an adhesive layer having a top and bottom face which may be adhered to a container. A base layer overlies the first adhesive layer. A discontinuous second layer of adhesive surrounds the perimeter of the base layer. A discontinuous fluid layer, such as a viscous solution, e.g. oil, is provided within the perimeter of the base layer that is within the second adhesive layer. A material layer is provided over the second adhesive layer and the oil layer. A third adhesive layer overlies the material layer and provided over the third adhesive layer is a continuous cover layer. The first adhesive layer, base layer, and material layer have at least one aligned opening to allow for the expulsion of air from the interior of a receptacle when the multi-layer control device is attached to a receptacle.

The present invention also includes a method of constructing the multi-layer valve assembly of the present invention. The method includes printing or otherwise providing at least one registration mark either on a web or release liner or the first adhesive layer. A first layer of adhesive is applied on the release liner and a base layer is placed on top of the first adhesive layer. At least one opening is cut in the first adhesive layer or alternatively the at least one opening is provided by pattern coating the adhesive layer on the release layer or web. At least one opening in the base layer is cut such that the openings of the base layer and first adhesive layer are aligned with one another and are aided in their formation alignment through use of the registration marks. A discontinuous second layer of adhesive is applied around the perimeter of the base layer. Next, a discontinuous fluid layer is applied within the area of the perimeter of the base layer. A material layer is provided over the second adhesive layer and fluid layer. Lastly, at least one opening is cut in the material layer. A third adhesive layer is provided over the material layer but does not cover the at least one opening in the material layer. The final cut may be aligned with the other openings using the registration marks. A cover layer is provided over the third adhesive layer. If multiple openings are provided in the layers, then there is a single opening that extends generally upwardly from the first adhesive layer to the beneath the cover layer while the other openings have a terminus below the material layer, thus forming a tortuous path for gas escape in the second adhesive layer (below the material layer).

In a further exemplary embodiment of the present invention, a method of making a package having a one-way valve is disclosed and includes the steps of initially providing a carrier web having a valve assembly. The valve assembly including; a first layer of adhesive having a top and bottom face, a base layer having a perimeter, a second layer of adhesive, an fluid layer, a material layer, a third adhesive layer, and a cover layer, each of the first adhesive layer, base layer, and material layer having at least one opening. Next, providing a package having an opening in an outer wall. Then, placing the valve assembly on the outer wall such that the opening in the outer wall is aligned with the at least one opening in the first adhesive layer and finally filling the package with a gas emitting material.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1a-1f depict individual layers of the multi-layered control device;

FIG. 2 depicts a receptacle having a multi-layer control device of the present invention;

FIG. 2a depicts a side angle of a receptacle having a multi-layer control device of the present invention;

FIG. 3 depicts a sectional view of the multi-layered control device of the present invention; and

FIG. 4 illustrates a method of constructing a multi-layered control device of the present invention.

### DETAILED DESCRIPTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

The present invention provides a multi-layer fluid control device that allows for the expulsion of air, gas or other unwanted components from the interior of a container while providing a protective seal and preventing unwanted components from the exterior of a receptacle from entering the interior of a receptacle. Examples of unwanted components include but are not limited to moisture, air, certain gases etc The protective seal provided by the multi-layer control device of the present invention may be a hermetic or water resistant seal while allowing the expulsion of excessive gas pressure from the interior of a receptacle to which the multi-layer control device is attached. In a preferred embodiment of the present invention, the multi-layer fluid control device is a one-way valve.

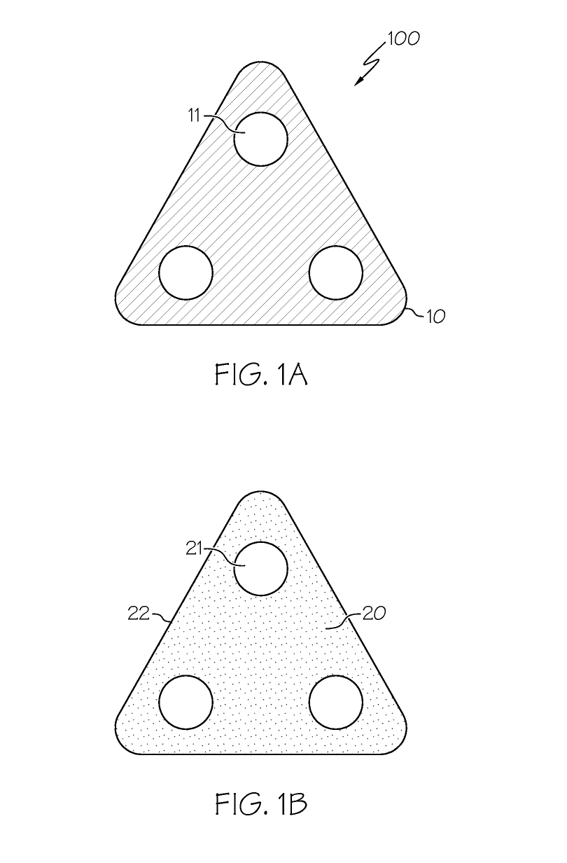

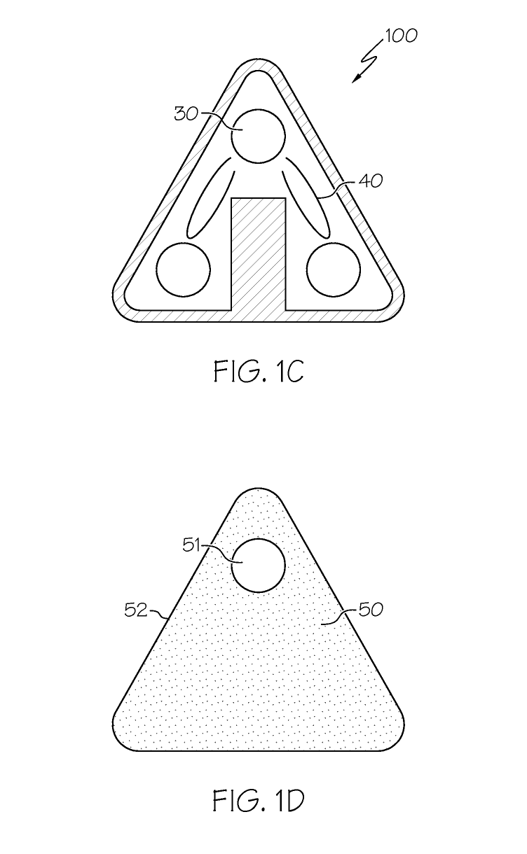

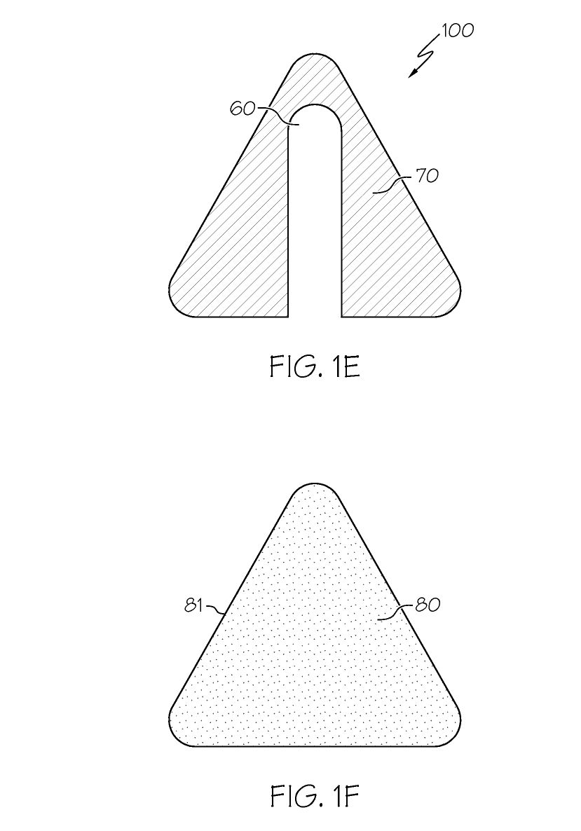

Referring now to the figures and initially to FIGS. 1a-1f, a first layer of the multi-layer control device 100 having a discontinuous fluid layer is provided. FIG. 1a illustrates the first layer of the multi-layer control device 100 of the present invention. The first layer of the multi-layer control device is a first adhesive layer 10. In one embodiment of the present invention, the first adhesive layer 10 is adhered to a receptacle having a wall structure. The first adhesive layer is preferably a permanent pressure sensitive adhesive, which is generally recognized as safe (“GRAS”) for indirect food packaging. The wall structure of the receptacle has at least one evacuation port 11 to allow the flow of excessive air or other unwanted components from the interior of a receptacle to the receptacle's surrounding environment. In another embodiment, the first adhesive layer 10 has at least one opening 11 to facilitate the expulsion of air from the interior of the receptacle. As illustrated in FIG. 1a, the first adhesive layer 10 may have a plurality of openings. While the base layer has been shown as generally a triangular shape, it should be understood that other configurations are acceptable. Likewise, while openings have been shown at each of the corners of the triangle, other arrangements are possible.

A base layer 20 having a perimeter 22 which will be provided over the first adhesive layer 10 as illustrated in FIG. 1b. The base layer has at least one opening 21 or a plurality of openings which correspond to the at least one opening 11 or plurality of openings in the first adhesive layer 10. In an additional embodiment it is contemplated where the at least one opening in the base layer 20 does not correspond (or is not aligned with) to the at least one opening in the first adhesive layer 10.

FIG. 1c illustrates a second adhesive layer 30 that is provided discontinuously around the perimeter 22 of the base layer 20. A fluid layer or an amount of fluid 40 is also provided discontinuously within the perimeter 22 of the base layer 20 and on the base layer 20. The fluid layer is provided within the perimeter of the base layer 20 in the areas not covered by the discontinuous second adhesive layer 30. The fluid layer 40 and the second adhesive layer 30 do not cover the at least one opening or plurality of openings in the first adhesive layer 10 and the base layer 20. It is contemplated that the fluid layer 40 may be applied in an area substantially equal to the area enclosed by the perimeter of the base layer. As used herein fluid layer refers to fluid in a particular layer and may not be readily defined as a distinct layer in the construction.

A material layer 50 will be provided over the discontinuous second adhesive layer 30 as well as the discontinuous fluid layer 40 as illustrated in FIG. 1d. The material layer 40 may cover some but not all of the plurality of openings in the base layer 20 and first adhesive layer 10. The material layer 50 has at least one opening 51 which corresponds to at least one opening 21 in the base layer 20 and the opening 11 first adhesive layer 10.

A “channel” 60, as illustrated in FIG. 1e, is created and corresponds to the at least one opening 11 in the first adhesive layer 10, the opening 21 in the base layer 20, and opening 51 in the material layer 50 to facilitate the expulsion of air from the interior of a receptacle through the channel 60 out the side of the multi-layer control device 100. The discontinuity of the second adhesive layer 30 and the fluid layer 40 aid in facilitating the formation of a channel and providing a tortuous path for the fluid or air egress. The fluid layer 40 further aids in providing a secure seal once the gases are expelled from the package. FIG. 1e further illustrates a third adhesive layer 70 which will be provided over the material layer 50 and does not cover the at least one opening 51 in the material layer 50 so as to leave the channel 60 open. The present invention contemplates that the third adhesive layer 70 may be applied around the perimeter of a cover layer 80 or a perimeter of the material layer 50 on the opposite side from the second adhesive layer. It is further contemplated that the third adhesive layer 70 covers the entire material layer 50 except for the at least one opening 51 in the material layer 50 to allow for the channel formation 60. In FIG. 1f a cover layer 70 having a perimeter 81 is provided over the third adhesive layer 70, covering the channel 60 completely including the at least one opening 51 in the material layer 50.

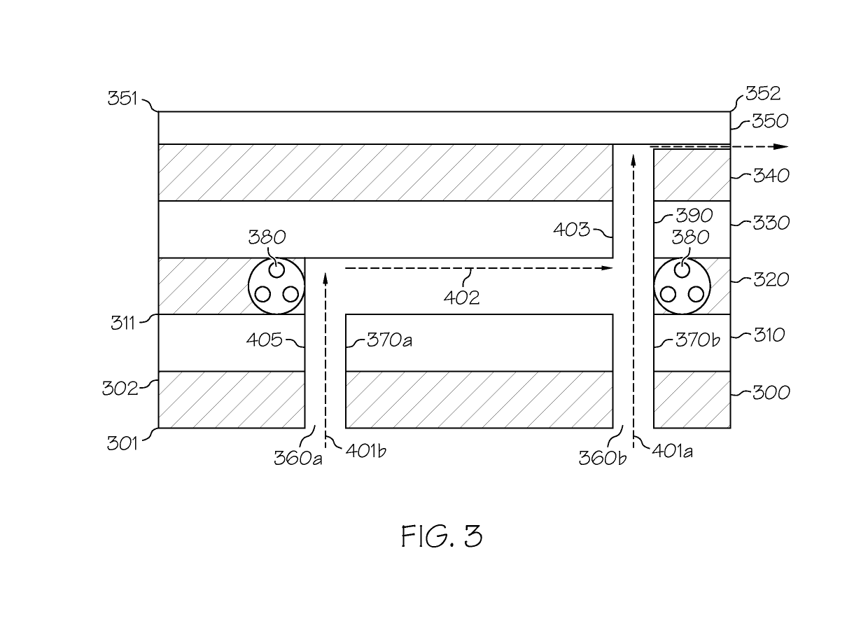

The air from the interior of the receptacle is expelled out of the interior of a receptacle and through a receptacle's at least one evacuation port and through the channel 60 created by the at least one opening (11, 21, 51) in each of the first adhesive layer 10, the base layer 20 and the material layer 50. If there are a plurality of openings in the first adhesive layer 10 and base layer 20 as illustrated in FIGS. 1a and 1b, additional air may be expelled through these openings which create a channel in addition to channel 60. This channel however may be covered by the material layer 50. Because these openings may be covered by the material layer 50, the pressure from the air expelled through these openings not included in the main channel 60 will be exerted on the material layer and will make its way via a tortuous pathway 402 illustrated in FIG. 3 over to the main channel 60 and will ultimately be expelled through a gas exit way indicated by reference numeral 404 in FIG. 3. The gas exit way is created between the third adhesive layer 70 and the cover layer 80 by the buildup of pressure underneath the cover layer 80. A portion of the cover layer will temporarily unseat itself from the third adhesive layer to permit the passage of air through the channel 60 and out the gas exit way 404 and into the surrounding environment. Once the gas is expelled, the cover layer 80 will reseat itself back onto the third adhesive layer 70 creating a reusable multi-layer control device

The present invention further contemplates that the material layer 50 may have more than one opening with each of the openings in the material layer 50 corresponding to and aligning with a plurality of openings in the first adhesive layer 10 and the base layer 20 creating more than one main channel 60 to facilitate the expulsion of air from the interior of a receptacle to the surrounding environment. The openings presently disclosed in the multiple layers of the multi-layer control device may be referred to as apertures. The apertures may be circular in shape but different geometrical shapes are contemplated by the present invention.

In a preferred embodiment of the present invention the perimeter 81 of the cover layer 80 and the perimeter 21 of the base layer 20 and a perimeter of the material layer 52 are aligned with one another and the layers of the multi-layer construction are substantially juxtapositioned on one another. However, the present invention contemplates that the multiple layers may be splayed slightly out of alignment from one another or may be positioned so to accommodate packaging requirements or designs.

The base layer 20, the material layer 50 and/or the cover layer 80 of the present invention in an exemplary embodiment is constructed out of a polyester such as polyethylene terphthalate (PET). The present invention contemplates that the base layer 20, the material layer 50, and/or the cover layer 80, do not need to be constructed out of the same type of material and may be dissimilar materials. In one embodiment, the base layer 10 and the cover layer 60 are constructed out of clear PET. However, the present invention further contemplates that pigments may be added to the base layer 10 and cover layer 60 in order to provide a colored multi-layer construction 100. In another embodiment the cover layer 80 is constructed out of foil laminate.

In the present invention the first layer of adhesive 10, the second layer of adhesive 30, and the third layer of adhesive 70 may be a pressure sensitive adhesive. The adhesive may be a form of an epoxy adhesive which is a versatile adhesive that can be used to join a variety of materials. Additionally, polyvinyl acrylate and toughened acrylics would also serve as suitable adhesives for the present invention. However, it is contemplated that the first and second layers of adhesive may also be a type of permanent adhesive in order to facilitate permanent adhesion of a multi-layer control device to the exterior surface of a receptacle. The adhesive that is selected is one that is generally recognized as safe (“GRAS”). Additionally, the multiple layer of adhesive may be applied in a pattern of water based adhesive dots. These dots may be tinted different colors. For example the second adhesive layer 30 may include blue tinted water based adhesive dots and the third layer 50 of adhesive may include red tinted water based adhesive dots. The adhesive layers may be applied via printing or other methods known in the art.

The present invention contemplates that the discontinuous fluid layer 40 may be a low viscosity fluid such as an oil. More specifically the oil may be a mineral or vegetable oil. Additionally, the fluid layer may also be another substance with a viscosity similar to that of oil or lower than oil but yet one that is still flowable. The fluid layer 40 of the present invention provides as a sealant to promote adhesion of the cover layer to the multi-layer control device. The fluid layer 40 prevents the entrance of unwanted components from the surrounding environment into the interior of a receptacle.

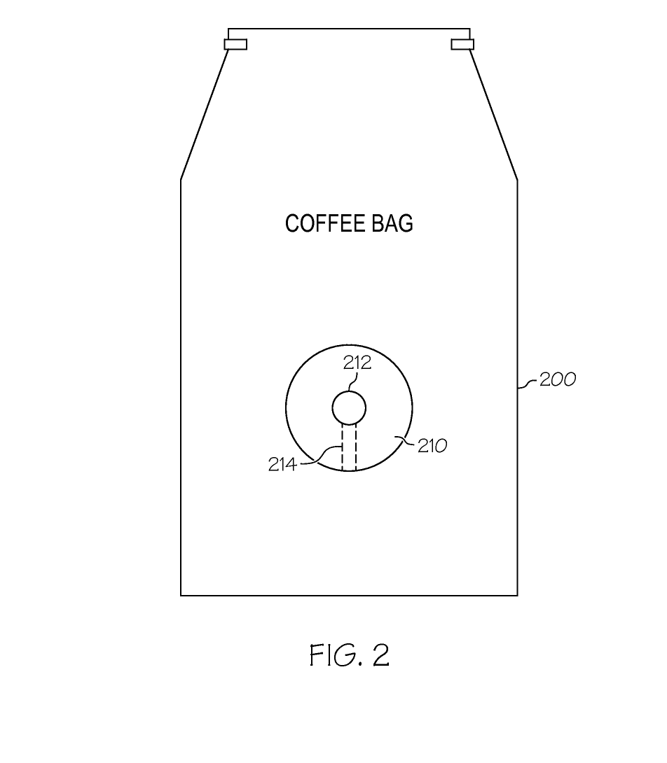

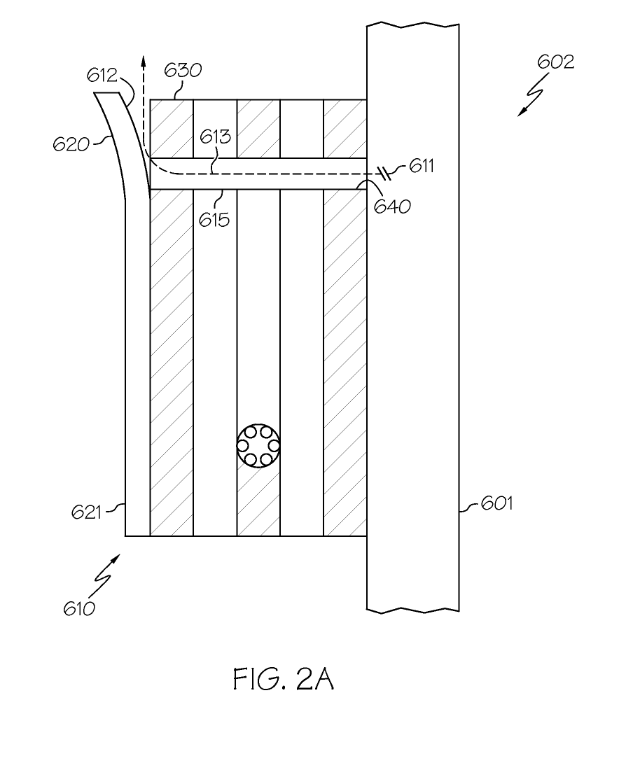

FIG. 2 illustrate the multi-layer control device 210 of the present invention adhered to a receptacle 200. The receptacle 200 may be containers or packages that hold coffee beans for example. The multi-layer control device is adhered over an evacuation port (not shown) in the wall structure of the receptacle 200. Types of receptacles that may utilize the multi-layer control device 210 of the present invention are numerous and may have many geometrical shapes and the products contained within the receptacles can vary as well. The present invention contemplates that the at least one opening 11 in the first adhesive layer 10 may be aligned with the evacuation port in the receptacle in order to facilitate expulsion of unwanted components but it is not required. In a preferred embodiment the openings in the base layer 20 and the first adhesive layer 10 and the cover layer 80 are aligned with the evacuation port in the wall structure of the receptacle 200. FIG. 2 also illustrates in phantom the gas egress opening and channel 212 and 214, respectively. The opening 212 corresponds to the opening in the material, base and adhesive layers allowing gas released from the package to travel to the surface beneath the cover layer and exit the assembly.

FIG. 2a illustrates a side view of a receptacle 602 having a multi-layer control device 610 of the present invention. The receptacle 602 has a wall structure 601 wherein the wall structure 601 has at least one evacuation port 611. The at least one opening 640 in the first adhesive layer is adhered over the at least one evacuation port 611 in the wall receptacle 601 of the receptacle 610. Excess air pressure 613 from within a receptacle's interior passes through the at least one evacuation port 611 and through the channel 615 of the multi-layer control device 610. The excess air exits into the surrounding environment via the gas exit way 612. The gas exit way 612 is created when the excess air 613 passes through the channel and pushes up on the second end 620 of the cover layer and the second end of the cover layer detaches from the third adhesive layer 630. The first section 621 of the cover layer remains adhered to the cover layer.

FIG. 3 illustrates a sectional view of the multi-layer control device 410 of the present invention. A first layer of adhesive 300 having a plurality of openings 360a, 360b, is provided. The first layer of adhesive 300 has a top 302 and a bottom face 301. The bottom face of the first adhesive layer 301 may be adhered to a release liner prior to application to a receptacle having a wall structure with an evacuation port. Overlying the top face 302 of the first adhesive layer 300 is a base layer 310. The base layer 310 has a plurality of openings 370a, 370b which correspond and align with the plurality of openings 360a, 360b, in the first adhesive layer 300. The base layer 310 has a perimeter 311. Discontinuously overlying the perimeter of the base layer 310 is a second layer of adhesive 320. Also discontinuously and partially surrounding the perimeter of the base layer is a fluid layer 380. The fluid layer 380 does not cover the second adhesive layer 320 and is provided on the perimeter of the base layer 310 which is not covered by the discontinuous second adhesive layer 320. However, the present invention does contemplate that the discontinuous fluid layer may overlie the discontinuous second adhesive layer.

The present invention contemplates that the fluid layer 380 is not limited to the perimeter 311 of the base layer 310. A material layer 330 covers the second adhesive layer 320 and the fluid layer. The material layer 330 has at least one opening 390 which aligns with at least one opening (360b, 370b) in the first adhesive layer 300 and the base layer 310. The material layer 330 covers openings 370a and 360a in the first adhesive layer 300 and the base layer 310 respectively. A third adhesive layer 340 is provided over the material layer 330. The third adhesive layer 340 may surround the perimeter of the material layer 330 or the cover layer 350 that overlies the third adhesive layer. The third adhesive layer 330 does not cover the at least one opening 390 in the material layer 330 with the at least one opening 390 in the material layer 330 being aligned with the openings 370b and 360b in the base layer 310 and the first adhesive layer 300 respectively. A main channel 403 is created by the opening 360b in the first adhesive layer 300, the opening 370b in the base layer 310 and the material cover layer 390. The second adhesive layer 320 and the fluid layer 380, and the third adhesive layer 340 facilitates the main channel's construction because they do not cover the at least one opening forming the channel 403. A second channel smaller than the main channel 405 is provided in the multilayer control device as a result of the openings 360a in the first adhesive layer 300 and the opening 370a in the base layer. The openings 360a and 370a are covered by the material layer 330. Air/gas 401b will enter the openings 360a and 370a through at least one evacuation port in a wall structure of a receptacle and travel through the second small channel 405. The air will travel along a pathway 402 which connects with main channel 403 and will join with air 401a that entered through the main channel 403. The combined air 401b and 401a will create pressure underneath the cover layer 350. The cover layer 350 has a first 351 and second end 352. Upon excess pressure from the combined air 401b and 401a from the main channel 403 the second end 352 of the cover layer 350 will separate from the third adhesive layer 340 creating a gas exit way 404 for the expulsion of air pressure between the second end 352 of the cover layer 350 and the third adhesive layer 340. The second end 352 is movable between an open and closed position. The second end 352 is in the open position when expelling excess air pressure from within a receptacle's interior and in the closed position when expulsion is complete. Once the air pressure is expelled the second end 352 of the cover layer 350 will reseat itself on the third adhesive layer 340. The ability of the cover layer 350 to reseat itself creates a reusable valve.

It is contemplated that the multi-layer control device 100 of the present invention is activated to release excess gas pressure from within the interior of a receptacle when the pressure within the interior of a receptacle exceeds a specific level or threshold. Thus, the multi-layer control device 100 of the present invention is designed to be able to withstand a certain amount of internal positive pressure before it becomes necessary to release air through the multi-layer control device 100. For example, generally when the internal pressure exceeds atmospheric pressure from about 689 pascals (Pa) to 103421 Pa, the multi layer control device 100 of the present invention will release internal pressure from a receptacle's interior. However the present invention contemplates that the multi-layer control device of the present invention may be designed to respond and release gases into the outside environment to variable amounts of pressure that are less than or significantly greater than 689 Pa to 103421 Pa wherein the variable amounts of pressure are dependent upon product design or requirements.

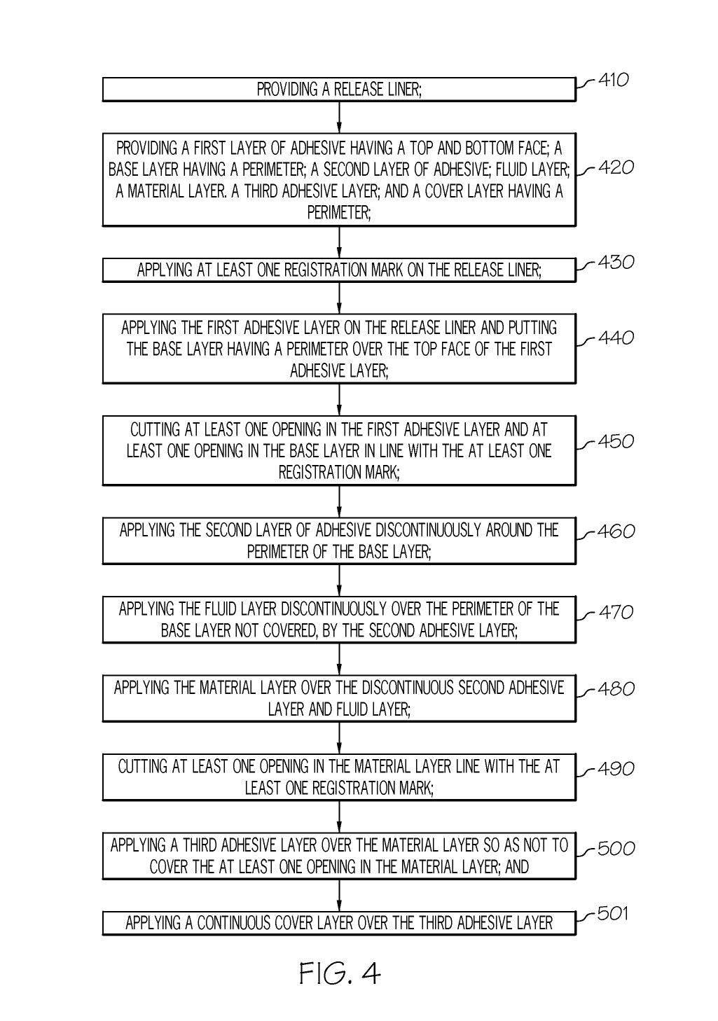

FIG. 4 illustrates a method of constructing the multi-layer control device of the present invention. First, in step 410 a release liner is provided and in step 420, the components of the assembly are generally constructed and include a first layer of adhesive with a top face and a bottom face, a base layer with a perimeter, a second layer of adhesive; a fluid or oil layer, a material layer a third adhesive layer and a cover layer having a perimeter are provided. Next, in step 430 at least one registration mark is printed on the web or release liner. A registration mark indicates where a cut is made within the various layers which will result in an opening or aperture in the present invention. It is also contemplated that a registration mark may be used to signal where to cut, align and separate a plurality of multi-layer control devices on a web from one another for individual utilization. The present invention contemplates that a plurality of registration marks or a single registration mark may be used. In another embodiment it is contemplated that the first layer of adhesive, or the edges of the adhesive layer, may serve as the at least one registration mark. It is preferred that if the first adhesive layer will serve as the registration mark(s) that the adhesive layer may be printed as a plurality of dots.

Still referring to FIG. 4 in step 440, the first adhesive layer is applied on the release liner and the base layer having a perimeter is placed on the top face of the first adhesive layer. Next, in step 450, at least one opening in the first adhesive layer and at least one opening in the base layer is cut in line using the at least one registration mark on the release liner as a guide. In step 460, the second layer of adhesive is discontinuously applied to surround the perimeter of the base layer. In step 470 a discontinuous low viscosity fluid or oil layer is applied to the areas of the perimeter of the base layer not covered with the second layer of adhesive. Next, in step 480, a material layer is applied over the discontinuous second adhesive layer and fluid layer. In step 490 at least one opening is cut in the material layer so that the cut corresponds to the position of registration mark on the web or release liner. The at least one opening in the material layer corresponds to and aligns with the at least one opening in the first adhesive layer and the base layer. In step 500, a third adhesive layer is applied over the material layer so as not to cover the at least one opening in the material layer. Lastly, in step 501, a continuous cover layer is provided over the third adhesive layer.

In one embodiment, the cutting of the openings in the layers may be accomplished using a die cutter, punch, laser cutter or slitting device. The present invention also contemplates that a laser cutter may be used to cut the openings in the different layers.

The present invention contemplates that the multi-layer control devices of the present invention may be constructed on a web that may be wound in rolls. It is also contemplated that the multi-layer control devices of the present invention may be provided on individual sheets, or in a cut sheet format rather than rolls.

The present invention further contemplates that the present invention may have layers in addition or less than to those already disclosed. For example, a fourth adhesive layer may be provided over the cover layer 80 over which another material layer may be applied or the middle film layer may be omitted.

It will thus be seen according to the present invention a highly advantageous valve has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

What is claimed is:

1. A multi-layer control device comprising:
a first layer of adhesive having a top and bottom face with the top face adhered to a base layer, the first adhesive layer having at least one opening;
the base layer having a perimeter and the base layer has at least one opening aligned with the opening in the first adhesive layer;
a discontinuous second layer of adhesive provided over the base layer and surrounds the perimeter of the base layer;
a discontinuous fluid layer provided within the perimeter of the base layer and is not covered by the discontinuous second layer of adhesive;
a material layer provided over the discontinuous fluid layer and discontinuous second layer of adhesive wherein the material layer has at least one opening;
a third adhesive layer provided over the material layer wherein the third adhesive layer does not cover the at least one opening in the material layer; and
a continuous cover layer overlying the third adhesive layer and covering the at least one opening in the material layer;

2. The multi-layer control device as set forth in claim 1, wherein the fluid layer of is a low viscosity fluid.

3. The multi-layer control device as set forth in any one of claim 1 or 2, wherein the fluid layer is one of a silicone oil, vegetable oil or mineral oil.

4. The multi-layer control device as set forth in any one of claims 1-3, wherein the fluid layer creates a tortuous path.

5. The multi-layer control device as set forth in any one of claims 1-4, wherein the base layer is PET.

6. The multi-layer control device as set forth in any one of claims 1-5, wherein the material layer is PET.

7. The multi-layer control device as set forth in any one of claims 1-6, wherein the multi-layer control device is a one-way valve.

8. The multi-layer control device as set forth in any one of claims 1-7, wherein the multi-layer control device is adhered to a receptacle.

9. The multi-layer control device as set forth in any one of claims 1-8, wherein the bottom face of the first adhesive layer is adhered to a release liner.

10. The multi-layer control device as set forth in any one of claims 1-9, wherein the third adhesive layer surrounds a perimeter of the material layer.

11. A method of making a package having a one-way valve comprising the steps of:
providing a carrier web having a valve assembly;
the valve assembly including;
a first layer of adhesive having a top and bottom face, a base layer having a perimeter, a second layer of adhesive, an fluid layer, a material layer, a third adhesive layer, and a cover layer, each of the first adhesive layer, base layer, and material layer having at least one opening;
providing a package having an opening in an outer wall;
placing the valve assembly on the outer wall such that the opening in the outer wall is aligned with the at least one opening in the first adhesive layer; and
filling the package with a gas emitting material.

12. A multi-layer control device, comprising:
a first adhesive layer having a top and bottom face with the bottom face adhered to a release liner and at least one opening wherein the top face is adhered to a base layer, the base layer having a perimeter and at least one opening;
a discontinuous second adhesive layer provided over the base layer that surrounds the perimeter of the base layer;
a discontinuous oil layer provided within the perimeter of the base layer that is not covered with the second adhesive layer;
a material layer having a perimeter provided over the discontinuous oil layer and second adhesive layer wherein the material layer has at least one opening;
a third adhesive layer provided over the material layer wherein the third adhesive layer surrounds the perimeter of material layer; and
a cover layer having a first and second end with the second end being separable from the third adhesive layer and movable between an open and a closed position.

13. A receptacle having a valve, comprising:
a receptacle having a wall structure where the wall structure has an evacuation port;
a valve, the valve comprising;
a first layer of adhesive having a top and bottom face where the bottom face is adhered to the wall structure of the receptacle and the first layer of adhesive has an opening that is in line with the evacuation port;
a base layer that overlies the top face of the first layer of adhesive where the base layer has a perimeter and an opening;
a discontinuous second adhesive layer that surrounds the perimeter of the base layer;
a discontinuous oil layer that is within the perimeter of the base layer not covered by the discontinuous second adhesive layer;
a material layer having at least one opening overlying the discontinuous second adhesive layer and oil layer;
a third adhesive layer provided over the material layer wherein the third adhesive does not cover the at least one opening in the material layer; and
a continuous cover layer having a first and second end overlying the third adhesive layer wherein the second end of the continuous cover layer is movable between an open and closed position.

14. The receptacle as set forth in claim 13, wherein at least one of the first adhesive layer, second adhesive layer, and third adhesive layer are pressure sensitive adhesive.

15. The receptacle as set forth in claim 13, wherein at least one of the first adhesive layer, second adhesive layer, and third adhesive layer are permanent adhesives.

16. The receptacle as set forth in claim 13, wherein the third adhesive layer surrounds a perimeter of the material layer.

17. A multi-layered control device comprising:
a first adhesive layer having a top face and a bottom face and defining an opening;
a base layer having a top surface and a bottom surface, the bottom surface of the base layer being disposed on the top face of the first adhesive layer, the base layer defining an opening that is aligned with the opening in the first adhesive layer;
a second adhesive layer disposed on the top surface of the base layer, the second layer provided in a discontinuous pattern about the top surface of the base layer;
a fluid layer disposed on the base layer, the fluid layer being disposed in an area not covered by the second adhesive layer; and
a cover layer overlying the second adhesive layer and the fluid layer.

18. The multi-layered control device of claim 17 further comprising:
a material layer disposed over the second adhesive layer and the fluid layer, the material layer defining an opening; and
a third adhesive layer disposed over the material layer and between the material layer and the cover layer such that the third adhesive layer does not cover the opening in the material layer.

19. The multi-layered control device of claim 18, wherein the cover layer has a first end and a second end, and the second end is movable between an open and closed position.

20. An article comprising:
(a) a receptacle having a wall structure and an evacuation port defined in the wall structure; and
(b) a valve, the valve comprising:
a first adhesive layer having a top face and a bottom face and defining an opening;
a base layer having a top surface and a bottom surface, the bottom surface of the base layer being disposed on the top face of the first adhesive layer, the base layer defining an opening that is aligned with the opening in the first adhesive layer;
a second adhesive layer disposed on the top surface of the base layer, the second layer provided in a discontinuous pattern about the top surface of the base layer;
a fluid layer disposed on the base layer, the fluid layer being disposed in an area not covered by the second adhesive layer; and
a cover layer overlying the second adhesive layer and the fluid layer.
